(19) United States
(12) Patent Application Publication
(10) Pub. No.: US 2021/0033500 A1
(43) Pub. Date: Feb. 4, 2021

(54) METHOD FOR DOSING AN AMOUNT OF LIQUID WITH A PERISTALTIC PUMP

(71) Applicant: Endress+Hauser Conducta GmbH+Co. KG, Gerlingen (DE)

(72) Inventors: Eva-Maria Petat, Stuttgart (DE); Christian Cramer, Stuttgart (DE); Ulrich Rottensteiner, Stuttgart (DE)

(21) Appl. No.: 16/934,321

(22) Filed: Jul. 21, 2020

(30) Foreign Application Priority Data
Jul. 29, 2019 (DE) 102019120414.3

(51) Int. Cl. G01N 1/14; G01N 27/74

(52) U.S. Cl. CPC G01N 1/14; G01N 2001/1427; G01N 27/74

(57) ABSTRACT

The present disclosure conveys a method for dosing an amount of liquid with a peristaltic pump in an analyzer, wherein the analyzer is configured to determine a concentration of a measurand of a sample, wherein the peristaltic pump includes at least one rotor having at least two rollers, the method comprising the steps: determining the position of at least one roller of the peristaltic pump; moving the rotor of the peristaltic pump to an initial position if it is not already in an initial position; and dosing the amount of liquid to be conveyed by moving the rotor by counting roller passes through a reference position. The present disclosure further discloses an analyzer for implementing the method.

### CROSS-REFERENCE TO RELATED APPLICATION

The present application is related to and claims the priority benefit of German Patent Application No. 10 2019 120 414.3, filed on Jul. 29, 2019, the entire contents of which are incorporated herein by reference.

### TECHNICAL FIELD

The present disclosure relates to a method for dosing an amount of liquid with a peristaltic pump in an analyzer, an analyzer, a computer program, and a computer-readable medium.

### BACKGROUND

In process measuring technology, e.g., in chemical, biotechnological, pharmaceutical, and food technology processes, as well as in environmental metrology, such automatic analyzers, also called analytical apparatuses, are used for determining a measurand of a liquid sample. Analyzers may, for example, be used to monitor and optimize the cleaning performance of a sewage treatment plant, to monitor drinking water, or to monitor the quality of foods. Measured and monitored is, for example, the proportion of a certain substance, which is also called an analyte, in a sample fluid, such as a liquid or a liquid mixture, an emulsion, a suspension, a gas, or a gas mixture. Analytes may, for example, be ions, such as ammonium, phosphate, silicate or nitrate, calcium, sodium or chloride, or biological or biochemical compounds, e.g., hormones, or even micro-organisms. Other parameters that are determined using analyzers in process measuring technology, especially in the field of water control, are sum parameters, such as total organic carbon (TOC), total nitrogen (TN), total phosphorus (TP), or chemical oxygen demand (COD). Analyzers may, for example, be designed as cabinet devices or buoys.

The sample to be analyzed is often treated in analyzers by mixing it with one or more reagents, thus causing a chemical reaction in the reaction mixture. The reagents are preferably selected such that the chemical reaction is verifiable by physical methods, e.g., by optical measurements, using potentiometric or amperometric sensors, or by a conductivity measurement. By means of a measuring sensor, measured values of a measurand that is correlated with the analytical parameter (such as COD) actually to be determined are detected accordingly. The chemical reaction may, for example, cause a coloring or a change of color which can be detected using optical means. In such cases, the intensity of the color is a measure of the parameter to be determined. As a measurand correlated with the parameter to be determined, an absorption or extinction of the sample treated may, for example, be determined by photometric means by feeding electromagnetic radiation, such as visible light, from a radiation source into the liquid sample, and receiving it with a suitable receiver after transmission through the liquid sample. The receiver generates a measurement signal, which depends upon the intensity of the radiation received, and from which the value of the parameter to be determined may be derived, e.g., based on a calibration function or a calibration table.

In analyzers for liquid analysis, both the sample to be analyzed and the reagents required for the reaction must be dosed into a reaction container (e.g., cuvette or reactor). Peristaltic pumps are frequently used for this purpose. As a rule, they dose small amounts of liquid with medium accuracy and simultaneously offer many advantages, such as self-priming and dry run safety.

In some fields of application of liquid analysis, however, the dosing accuracy of such peristaltic pumps is not good enough and must therefore be enabled by the use of further components. These are usually what are called dosing units, which consist of a plurality of elements (manifolds, valves, optical components, etc.). This ultimately makes it possible to dose very accurately. However, the costs of such a solution are correspondingly higher due to the larger number of components and thus have a negative effect on the equipment costs.

The exact dosing of an amount of liquid solely using a peristaltic pump is not sufficiently accurate for many applications in liquid analysis. This is due firstly to the pulsation of the peristaltic pump and secondly to an increasing tube wear and thirdly to the fact that the volume actually dosed is unknown in a conventional peristaltic pump. The delivery volume per revolution can change significantly due to tube aging.

As already mentioned, a peristaltic pump generally pulsates very strongly. This is due to its principle of conveyance. In peristaltic pumps, the installed tube is closed and compressed by rollers which are located on a rotor. When the rotor rotates, the rollers slide over the tube and displace the medium located in the tube in the direction of the pump outlet/pressure outlet. When a roller leaves the tube, the tube opens a chamber and causes a short-term volume reflux (corresponding to the volume of the squeezed tube piece) and a pressure surge. Application of a roller at the pump inlet can likewise cause a volume flow which briefly moves against the actual volume flow. Thus, pulsation occurs on the inlet side and the outlet side of peristaltic pumps.

As a result, the volume flow stalls, and time-dependent dosing inaccuracies occur depending on the position of the rollers. However, a uniform flow rate is enormously important for exact dosing of liquids. There are now several solution approaches to preventing the pulsation that arises. These include, e.g., passive and active pulsation damping, combination of pulsating volume flows, or a larger number of rollers.

To dose a volume using a peristaltic pump, the rotational speed of the pump motor is adjusted, and the pump is operated for a specific, predetermined time. If the pump runs longer or faster, more medium is delivered. If the rotational speed (or the executed angle of rotation) deviates from the target during the predetermined time, the dosed volume is inevitably wrong. Because the dosing volume in conventional peristaltic pumps is set solely using the time or, in the case of stepper motors, using the number of steps, there is never any feedback as to how many revolutions or steps have actually been carried out in this time, and the true dosed volume is unknown. Moreover, the behavior of the pump changes due to aging, especially, due to the aging of the tube. If the same time continues to be set, different volumes will be delivered as the peristaltic pump ages. The pump must therefore be regularly calibrated so that the pump in fact runs for the correct time for a given delivery volume. Relatively precise dosing is possible with the aid of this calibration. However, the problem of lack of feedback of the actually performed angle of rotation remains. As a result, it is unknown whether and how much the pump has rotated at all.

Known solutions, however, are often implementable only with high technical outlay or are associated with high costs.

### SUMMARY

The object of the present disclosure is to improve the dosing accuracy of peristaltic pumps in analyzers in process automation.

The object is achieved by a method for an otherwise conventional analyzer with a peristaltic pump, wherein the peristaltic pump comprises at least one rotor having at least two rollers, wherein the method comprises the steps: determining the position of at least one roller of the peristaltic pump; moving the rotor of the peristaltic pump to an initial position if it is not already in an initial position; and dosing the amount of liquid to be conveyed by moving the rotor by counting roller passes through a reference position.

Counting roller passes through a reference position should be considered equivalent to counting revolutions.

The position of the rollers within a peristaltic pump is thus detected, and it is possible to predict and take account of the magnitude and number of unavoidable pulsations in each of the dosing steps. This enables exact dosing of an amount of liquid.

If there is a plurality of amounts of liquid to be conveyed, the absolute volume is less important than the ratio. For example, if 1 ml of a first amount of liquid and 2 ml of a second amount of liquid are required, twice the number of roller passes are used for the second amount of liquid.

The smallest reasonable amount that can be dosed in this case is the volume in the tube during a roller pass. If an amount of liquid to be dosed cannot be dosed by an integral multiple of this smallest amount that can be dosed, the amount of liquid to be dosed in one embodiment is either increased or decreased depending on the application to an integral multiple of this smallest amount that can be dosed. If, for example, 1.1 ml are to be dosed, but the smallest amount that can be dosed is 0.25 ml, the volume to be dosed is, for example, reduced to 1.0 ml so that this can be dosed by an integral multiple of the smallest amount that can be dosed, i.e., 4*0.25 ml in this case. As mentioned, what is critical is not the absolute volume but the ratio of the various amounts of liquid to be dosed.

One embodiment provides that the method comprises the step: discarding the contents of the tube located in the region of the tube which is on the outlet side before the initial position is reached.

The object is further achieved by a peristaltic pump comprising at least one peristaltic pump having a rotor with at least two rollers, and a data processing unit configured to carry out the method steps as explained above.

One embodiment provides that the analyzer comprises a counting unit for counting roller passes through a reference position.

One embodiment provides that the counting unit comprises a switch which is closed when the roller passes.

One embodiment provides that at least one roller comprises a magnet and the counting unit comprises a magnetic sensor, especially, a reed contact or a Hall effect sensor.

One embodiment provides for the counting unit to comprise a light barrier.

The object is further achieved by a computer program comprising commands which cause the analyzer to perform as described above the method steps as described above.

The object is further achieved by a computer-readable medium on which the computer program according to the preceding claim is stored.

### BRIEF DESCRIPTION OF THE DRAWINGS

This is explained in more detail with reference to the following figures:

FIG. 1 shows a claimed automatic analyzer in a symbolic overview;

FIG. 2 shows the system design of the claimed analyzer;

FIGS. 3a and 3b show two positions of rollers of a peristaltic pump;

FIGS. 4a and 4b show an embodiment of the peristaltic pump in a first and a second position; and

FIGS. 5a and 5b show an embodiment of the peristaltic pump in a first and a second position.

In the figures, the same features are identified by the same reference signs.

### DETAILED DESCRIPTION

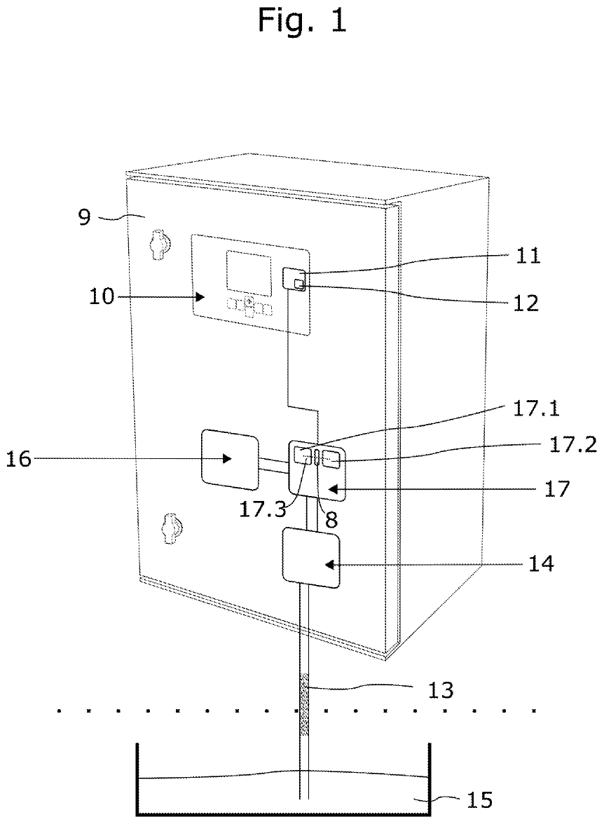

The entirety of the claimed automatic analyzer is denoted by reference sign 1 and is shown in FIG. 1.

To be measured is, for example, the direct absorption of a substance or the intensity of a color, which is generated by converting the substance to be determined into a color complex by means of reagents. Further possible measurands that function according to a similar principle are turbidity, fluorescence, etc. An application example is the measurement of the chemical oxygen demand (COD), wherein COD is a sum parameter, which means that the measured value results from the sum total of the substances and cannot be attributed to a single substance. In this measurement method, a change of color is generated in a reactor; see below. Other possible parameters are, for example, total carbon, total nitrogen, or an ion concentration, such as the concentration of the ions of ammonium, phosphate, nitrate, etc.

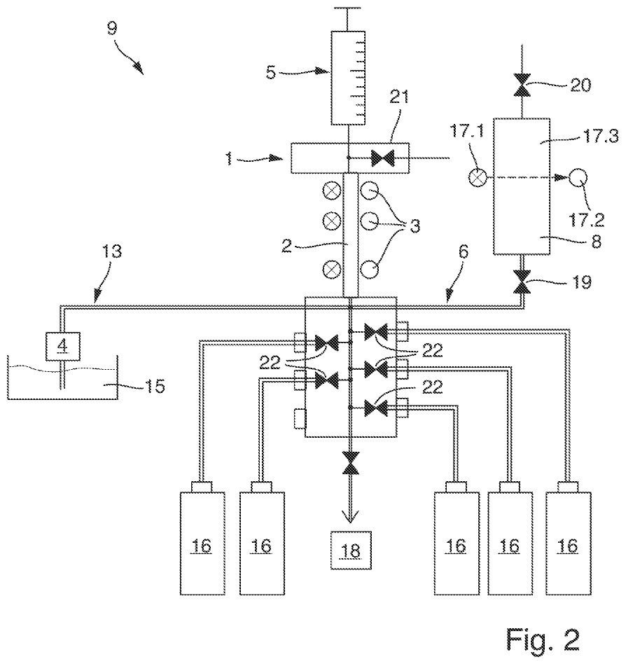

A sample 13 is taken from the medium 15 to be analyzed, for example, a liquid or a gas. Usually, taking the sample 13 happens fully automatically by means of the analyzer itself, by subsystems 14, such as pumps, tubes, valves, etc., for example. For determining the substance content of a certain species, one or more reagents 16 that were developed specifically for the respective substance content and that are available in the housing of the analyzer are mixed with the sample 13 to be measured. This is shown in a symbolic manner in FIG. 1. In practice, various vessels are provided with different reagents, which are extracted by means of the aforementioned pumps, tubes, and valves, etc. and mixed as necessary. This is illustrated in FIG. 2. Separate pumps, tubes, and valves can also be used for each process (taking the sample, mixing of reagents, etc.).

A color reaction of the mixture caused in this way is subsequently measured by means of an appropriate measuring device, such as a photometer 17. For this purpose, the sample 13 and the reagents 16 are, for example, mixed in a measuring chamber 8 and optically measured with light of at least one wavelength using the transmitted light method. In the method, light is transmitted through the sample 13 by a sender 17.1. A receiver 17.2 for receiving the transmitted light is assigned to the sender 17.1, wherein an optical measuring path 17.3 (indicated by a dotted line in FIG. 1) runs from the sender 17.1 to the receiver 17.2. The sender 17.1 comprises, for example, one or more LEDs, i.e., one LED per wavelength, or an appropriate light source with broadband excitation. Alternatively, a broadband light source with a corresponding filter placed in front of it is used, which filter can also, depending on the application, be mounted directly in front of the receiver. The receiver 17.2 can, for example, comprise one or more photodiodes.

The measured value is generated by the receiver based on the light absorption and a stored calibration function. The analyzer 9 comprises a transmitter 10 with a microcontroller 11 along with a memory 12. The analyzer 9 can be connected to a field bus via the transmitter 10. Furthermore, the analyzer 9 is controlled via the transmitter 10. Thus, the taking of a sample 13 from the medium 15, for example, is initiated by the microcontroller 11 by means of appropriate control commands to the subsystems 14. The measurement by the photometer 17 is also controlled and regulated by the microcontroller. The dosing of the sample 13 can also be controlled by the transmitter 10. A computer program for controlling the analyzer, for example for dosing, then runs on the transmitter 10. A computer-readable medium is also located on or can be plugged into the transmitter 10.

The taking of the sample 13 is now described in principle. For taking the sample 13 from the medium 15, a sample taking apparatus is used that can, for example, comprise a pump 4, here a peristaltic pump. The sample 13 passes into a dosing apparatus 1 via a medium line. As mentioned, the analyzer 9 comprises liquid containers that contain reagents 16 to be added to the sample 13 for determining the measurand of the analyzer 9 and standard solutions for calibrating and/or adjusting the analyzer 9. The peristaltic pump 4 pumps the sample 13 into the dosing apparatus 1.

The dosing apparatus 1 comprises a dosing chamber 2, which is, for example, designed as a cuvette, and at least one dosing light barrier 3. FIG. 2 shows three light barriers 3, wherein two of them serve as measuring light barriers for measuring a certain amount of liquid, and the top one serves as safety light barrier. If the liquid to be measured in the dosing chamber 2 reaches the top light barrier, an alarm is triggered, and the dosing is stopped. The light barriers 3 can also be designed as infrared light barriers with daylight filters. A valve 21 for ventilation is also connected to the dosing apparatus 1. A pump 5, more precisely a displacement pump, more precisely a piston pump, is also connected to the dosing apparatus 1. The piston pump 5 pumps the liquid from the dosing chamber 2 into the reactor 8. This happens because air is drawn in during the drawing up of the piston pump 5, and this air column pushes before it the liquid from the dosing chamber 2 toward the reactor 8.

The dosing apparatus 1 is connected by means of a line 6 to the measuring chamber 8, also called reactor 8. The line 6 is designed as a tube or pipe.

The reactor 8 comprises a valve 19 on the side of the line 6 and a valve 20 for venting on the opposite side.

The reagents 16, or the containers containing the reagents 16, are connected to the dosing apparatus 1 via liquid lines. There are appropriate valves 22 for switching the line. There is furthermore an outlet 18, which comprises a valve where applicable and serves as drain.

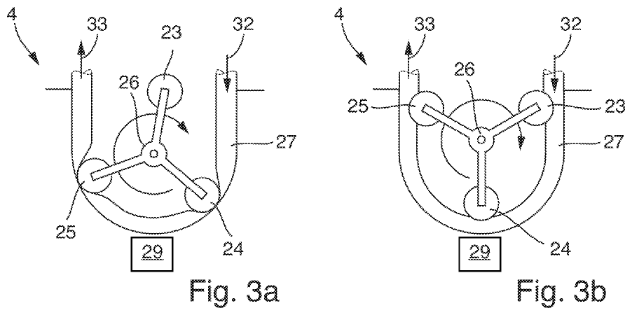

FIGS. 3a and 3b show a peristaltic pump 4 of the analyzer 9. Said pump comprises, in the example, three rollers 23, 24, 25 on a rotor 26. To solve the disadvantages of a peristaltic pump described above, detection of at least one of the rollers 23, 24, 25 in the interior of the peristaltic pump 4 is disclosed.

In general, a peristaltic pump is a displacement pump in which the amount of liquid to be conveyed is forced through a tube 27 by external mechanical deformation of said tube. An amount of liquid to be dosed flows in through the inlet 32 and out through the outlet 33. In each case, the tube 27 is supported on the outside of the housing of the pump head and is clamped from the inside by rollers or shoes which rotate on a rotor 26. Here, the movement causes the clamping point to move along the tube 27 and to thereby push forward the liquid amount to be conveyed.

FIG. 3a shows a first position of the rotor 26, FIG. 3b a second position. First, the position of at least one roller 23, 24, 25 is determined in FIG. 3a. In principle, the position could also be detected directly at the rotor. Here, however, a counting unit 29 (see details below; the counting unit is symbolically represented as a rectangle in FIGS. 3a and 3b) is used to detect where whether a roller 23, 24, 25 is located at the counting unit.

If it is recognized that the rotor 26 is already in the initial position, dosing can begin immediately (see below). If the rotor 26 is not in the initial position (as is the case in FIG. 3a), it is first moved into the initial position. FIG. 3b, for example, shows this initial position, in which a roller, here the roller 24, is oriented vertically downward.

If the position at the beginning of a dosing step is known, that is to say, because of which the initial position, a software algorithm stored in the transmitter 10 can be used to configure the required revolutions such that the same number of pulses, i.e., roller passes through the counting unit 29, always occurs for a certain amount of liquid. This ensures that the dosed volume is always approximately constant. For this method of compensating to be applicable to every tube type and every degree of tube wear, the transported volume is measured at regular intervals during a dosing step and the peristaltic pump is thus calibrated.

If it is determined that the rotor 26 is not in the initial position, the amount of liquid located in the section closer to the output 33 is discarded. In FIG. 3a, this is the part of the tube 27 after the roller 25 in the direction 33. In one embodiment, there lastly follows a “flush” with air or nitrogen, more generally with a flushing medium, so that it is ensured that the tube 27 is empty or free of undesired media.

The unit which determines the position of the rollers at the beginning does not necessarily have to be the unit which counts the roller passes. However, this is preferably configured as a single unit, the counting unit 29.

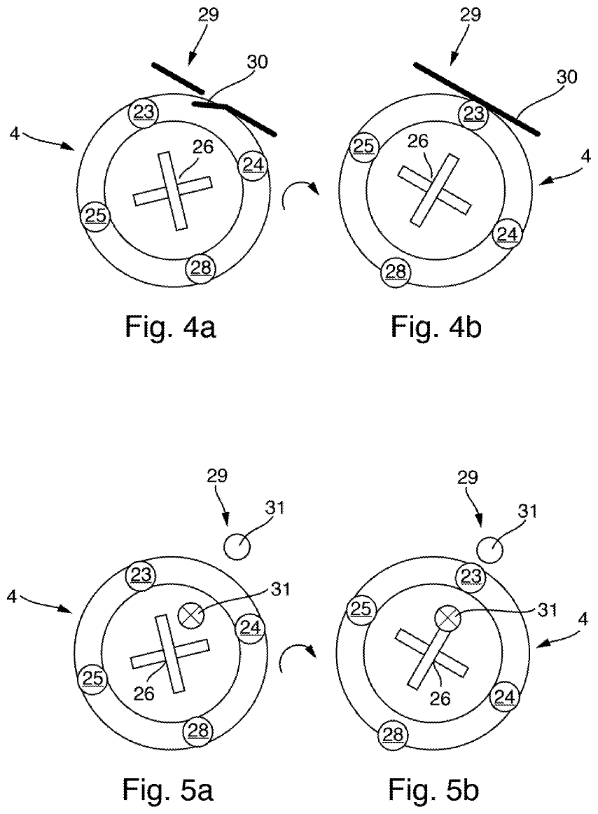

FIGS. 4a and 4b show an embodiment of the detection of the initial position and/or the counting of the roller passes. FIG. 4a shows a first position; FIG. 4b shows the initial position. In this and in the next example, the peristaltic pump 4 has four rollers 23, 24, 25, 28. In this embodiment, detection takes place by means of a switch 30. A roller 23, 24, 25, 28 of the peristaltic pump 4 closes a switching mechanism when it passes the switch 30. This produces an electrical connection which generates the signal for the transmitter 10. In this way, the position of the rollers can be processed.

In one embodiment, detection takes place by means of magnetic switches. Here, the reference position of the rollers is detected via a magnetic contact. A magnetic switch which is fixed in place outside the rotor 26 is actuated at each revolution by means of a magnet located on the rotor 26 of the peristaltic pump 4. The switch is configured as, for example, a magnetic sensor, e.g., a reed contact or as a Hall effect sensor. This produces an electrical signal which can be processed by the software and the corresponding algorithm.

In the embodiment in FIGS. 5a and 5b, detection takes place by means of a light barrier 31. FIG. 5a shows a first position; FIG. 5b shows the initial position. For detection by means of light barrier 31, a sender and a receiver are placed at the initial position to be determined. The light emitted by the sender is interrupted at the moment when a roller 23, 24, 25, 28 of the peristaltic pump 4 passes the light barrier 31 and can thus no longer be detected by the receiver sensor. The position of the roller 23, 24, 25, 28 is then considered to be detected.

This results in a methodology for increasing the dosing accuracy of a peristaltic pump 4 by detecting the initial position of the rollers 23, 24, 25, 28 in the interior of the peristaltic pump 4. If the position of the rollers before the beginning of a dosing step is known (initial position), the number of occurring pulses can be predicted and accordingly taken into account when calculating the volume for dosing. This detection can be done, for example, by means of a switch, magnetic switch, or light barrier.

Claimed is:

1. A method for dosing an amount of liquid with a peristaltic pump in an analyzer configured to determine a concentration of a measurand of a sample, the method comprising:
providing a peristaltic pump that includes a tube and at least one rotor including at least two rollers, which are configured to contact and deform the tube, the tube having an inlet side and an outlet side;
determining a position of at least one of the at least two rollers of the peristaltic pump;
moving the at least one roller into an initial position when the at least one roller is not yet in an initial position; and
dosing a desired amount of liquid by moving the at least one roller by counting roller passes through a reference position.

2. The method of claim 1, further comprising discarding contents of the tube of the peristaltic pump disposed in a region of the tube that is on the outlet side before the initial position is reached.

3. An analyzer for determining a concentration of a measurand of a liquid sample, the analyzer comprising:
a peristaltic pump that includes a tube and at least one rotor including at least two rollers, which are configured to contact and deform the tube, the tube having an inlet side and an outlet side; and
a data processing unit configured to perform the method according to claim 1.

4. The analyzer of claim 3, further comprising a counting unit configured and arranged to count roller passes through the reference position.

5. The analyzer of claim 4, wherein the counting unit comprises a switch that is activated when the at least one roller passes through the reference position.

6. The analyzer of claim 4, wherein the at least one roller comprises a magnet, and the counting unit comprises a magnetic sensor.

7. The analyzer of claim 6, wherein the magnetic sensor is a reed contact sensor or a Hall effect sensor.

8. The analyzer of claim 4, wherein the counting unit comprises a light barrier.

9. A computer program comprising instructions which cause the analyzer to perform the method of claim 1.

10. A computer program product comprising a non-transitory machine-readable storage medium encoding instructions that, when executed by one or more programmable processors, cause the one or more programmable processors to perform the method of claim 1, wherein the data processing unit includes the one or more programmable processors.
